(19) United States
(12) Patent Application Publication
(10) Pub. No.: US 2016/0247203 A1
(43) Pub. Date: Aug. 25, 2016

(54) Segmented Advertisement

(71) Applicant: Yieldmo, Inc., New York, NY (US)

(72) Inventors: Michael Yavonditte, New York, NY (US); David Michael Goligorsky, New York, NY (US); Connor Francis Doherty, New York, NY (US)

(73) Assignee: Yieldmo, Inc., New York, NY (US)

(21) Appl. No.: 15/048,994

(22) Filed: Feb. 19, 2016

Related U.S. Application Data
(60) Provisional application No. 62/119,176, filed on Feb. 21, 2015.

(51) Int. Cl. G06Q 30/02

(52) U.S. Cl. CPC G06Q 30/0267; G06Q 30/0277

(57) ABSTRACT

An advertising system and method is provided for use with advertisements on mobile devices. The advertisement is divided into segments and in the event that all of the segments are not displayed the first time the advertisement is displayed, the next time the advertisement will begin displaying with a segment other than the first segment.

### CROSS REFERENCE TO RELATED APPLICATIONS

This application claims the benefit of the filing date of U.S. provisional patent application No. 62/119,176 entitled “Segmented Advertisement”, which was filed on Feb. 21, 2015, by the same inventors of this application. That provisional application is hereby incorporated by reference as if fully set forth herein.

### FIELD OF THE INVENTION

The invention relates generally to digital advertisements and more particularly but not exclusively to partitioning a digital advertisement into segments and determining which segments of the advertisement to display based on which segments of the advertisement were displayed during a previous instance when the advertisement was displayed.

### BACKGROUND OF THE INVENTION

Digital advertisements are extremely important marketing tools. With the proliferation of computers, smart phones, tablets, networks, the Internet, etc. it is more important than ever to keep advertisements interesting to the consuming public. Often-times, a consumer will become bored or annoyed when the same advertisement is repeatedly shown every time that consumer views a webpage or an application. Additionally, in the event of a multimedia advertisement or some other animated type of advertisement, when the consumer is forced to always watch the advertisement from the beginning it may incentivize the consumer to leave the webpage or that portion of the page as quickly as possible to avoid the advertisement. This makes it challenging for marketers and advertisers to deliver the entirety of their marketing message.

It would thus be advantageous to create a method of serving a digital advertisement in such a way that if the advertisement is not displayed in its entirety the first time that it is served, the next time that it is served the display begins at or about the point where the previous display was halted. It would be further advantageous to create such an advertisement that enables the consumer to view different segments of the advertisement based on previously unpresented segments.

### BRIEF SUMMARY OF THE INVENTION

Many advantages of the invention will be determined and are attained by the invention, which in a broad sense provides a segmented digital advertisement that determines which segments to display based upon which segments were previously displayed and/or which segments were previously not displayed. In one or more embodiments the digital advertisement includes a video advertisement which is segmented. If every segment of the advertisement that was intended to be displayed is not displayed prior to the consumer leaving the webpage, an area of the webpage, or an application (depending on where the advertisement is being served), the next time the advertisement is displayed it will begin with a segment of the advertisement that was not previously displayed or with one or more segments that were previously displayed (to provide context) and then with one or more additional segments that were not previously displayed.

In one or more implementations of the invention, a method for providing a graphical user interface for displaying a digital advertisement is provided. The method includes an advertisement server dividing an advertisement into segments. The advertisement server transmits the advertisement over a network for display on a mobile device. The advertisement server determines that not all of the segments were displayed and in a subsequent transmission of the advertisement for display on said mobile device the advertisement server transmits only one or more segments which were not previously displayed.

In one or more implementations of the invention, a method for providing a graphical user interface for displaying a digital advertisement is provided. The method includes a mobile device receiving an advertisement which is divided into segments. The mobile device displays at least one of the segments in response to a triggering event but terminates display of additional segments prior to displaying each of the segments. The mobile device keeps track of where the display of additional segments terminated and a subsequent time that the mobile device displays the advertisement the mobile device displays only one or more segments which were not previously displayed.

In one or more implementations of the invention, a method for providing a graphical user interface for displaying a digital advertisement is provided. The method includes a mobile device receiving an advertisement which is divided into segments. The mobile device displays at least one of the segments on an area of a webpage in response to a triggering event. The mobile device stops displaying additional segments of the advertisement upon a user navigating away from area of the webpage to another area of the webpage. The mobile device displays at least one other segment, which was not previously displayed, on the other area of the webpage in response to a determination that all of the segments were not previously displayed.

The invention will next be described in connection with certain illustrated embodiments and practices. However, it will be clear to those skilled in the art that various modifications, additions and subtractions can be made without departing from the spirit or scope of the claims.

### BRIEF DESCRIPTION OF THE DRAWINGS

For a better understanding of the invention, reference is made to the following description, taken in conjunction with the accompanying drawings, in which like reference characters refer to like parts throughout, and in which:

FIG. 1 is an illustration of a digital advertisement which has been segmented in accordance with one or more embodiments of the invention;

FIG. 2 is an illustration of the advertisement according to FIG. 1 presented on a webpage in which only some of the segments are presented for viewing prior to a consumer leaving the webpage;

FIG. 3 is an illustration of the webpage and advertisement of FIG. 2 in which the consumer returns to the webpage or visits a different webpage from the same website or from a different website and additional previously not presented segments of the advertisement are presented for viewing prior to the consumer leaving the webpage;

FIG. 4 illustrates one or more alternate embodiments of the illustration of FIG. 3 in which at least one of the prior presented segments of the advertisement is/are presented upon the return of the consumer in addition to previously not presented segments;

FIG. 5 illustrates one or more alternate embodiment of the illustration of FIG. 3 in which at least two of the prior presented segments of the advertisement are presented upon the return of the consumer in addition to previously not presented segments;

FIG. 6 illustrates one or more alternate embodiments of the illustration of FIG. 2 in which the segments of the advertisement are presented in a different sequential order;

FIG. 7 illustrates the webpage and advertisement of FIG. 6 in which the consumer returns to the webpage or visits a different webpage from the same website or from a different website and additional previously not presented non-sequential segments of the advertisement are presented for viewing prior to the consumer leaving the webpage;

FIG. 8 is an illustration of the advertisement according to FIG. 1 presented on a webpage in which some of the segments are presented for viewing on one area of the webpage and additional segments of the advertisement are presented for viewing on a different area of the webpage; and,

FIG. 9 illustrates a system for generating an advertisement in accordance with one or more embodiments of the invention.

The invention will next be described in connection with certain illustrated embodiments and practices. However, it will be clear to those skilled in the art that various modifications, additions, and subtractions can be made without departing from the spirit or scope of the claims.

### DETAILED DESCRIPTION OF THE INVENTION

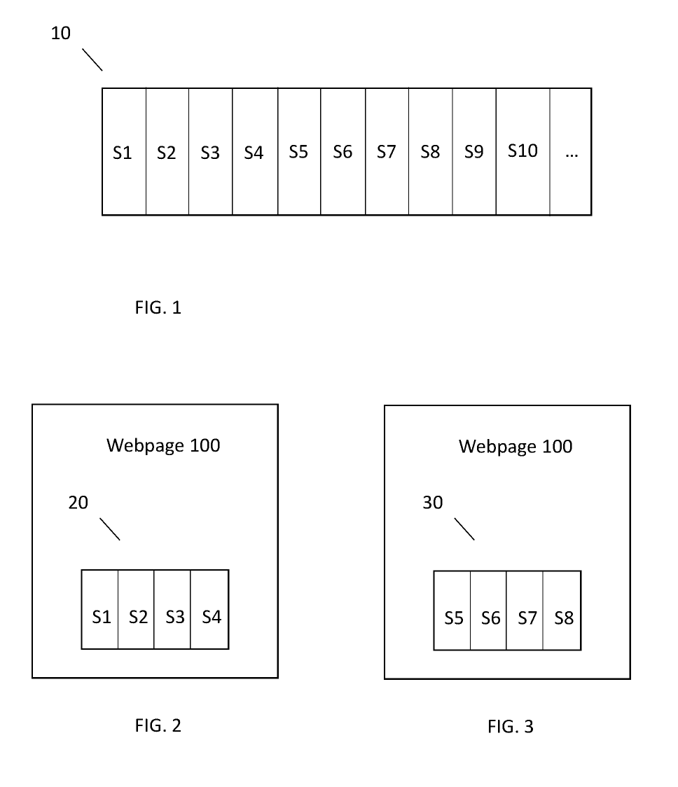

Referring to the drawings in detail wherein like reference numerals identify like elements throughout the various figures, there is illustrated in FIGS. 1-9 systems and methods for segmenting a digital advertisement and determining which segments to display based on which segments have already been displayed. While the following description will be limited to displaying the advertisement in a webpage on a mobile device, the claims are not intended to be so limited. The following description is applicable to web pages displayed on a computer (e.g. a desktop or laptop device) and to those displayed on a mobile device (e.g. personal digital assistants (PDA), mobile phones, tablets, e-readers, portable game units, smart watches, etc.) it is also applicable to an advertisement displayed within a mobile application (“app”) (collectively and individually also referred to as a consumer device).

FIG. 1 illustrates a digital advertisement 10 which has been divided into segments S1-S10. Those skilled in the art will recognize that the advertisement could take any form of advertisement such as, but not limited to, an image, a graphic, a video, multimedia, etc. and will also recognize that while 10 segments S1-S10 are illustrated and the following description will be limited to 10 segments S1-S10, the number of segments, the shape and the size of each segment is a design choice. The advertisement 10 could be divided into fewer than or more than 10 segments S1-S10, and each segment S1-S10 could be the same size, different sizes, some could be the same and others different, or any combination thereof. The shape of the segments S1-S10 may be the same or they may be different or some may be the same and some may be different. The advertisement 10 could be segmented based on time (e.g. a duration such as blocks of time or a sequential time such as seconds 1-5, 6-10, or some other time period, etc.), based on a number of frames (e.g. for a video), or based on an amount of content or some combination of the above.

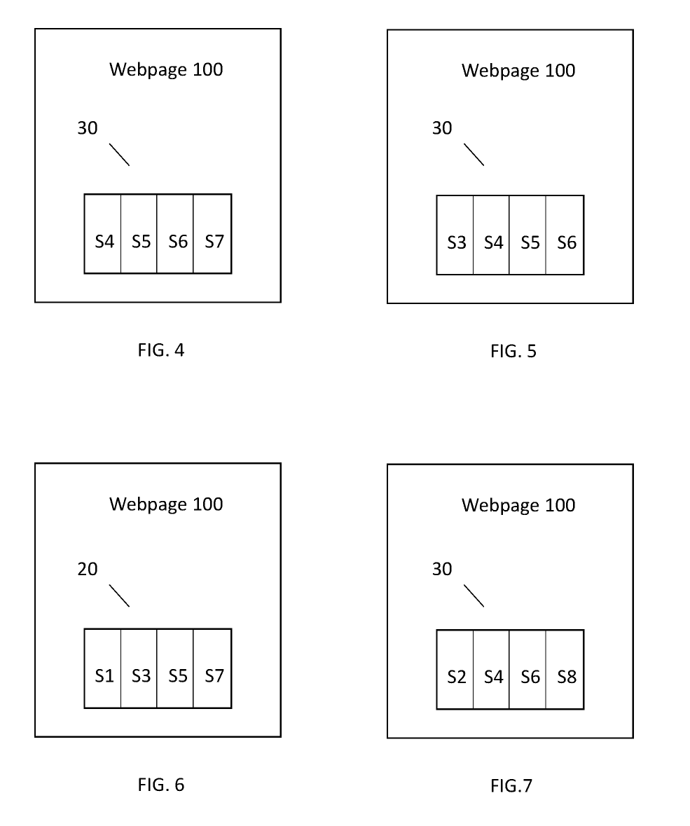

FIGS. 2-8 illustrate various ways, although not necessarily every way, in which a segmented advertisement 10 may be employed. For example, as illustrated in FIG. 2, the advertisement 10 may be displayed on a webpage 100. Those skilled in the art will recognize that there are various conventional triggers for presenting an advertisement 10 such as, but not limited to, tapping or clicking the advertisement 10, scrolling through the page, passing the pointer over the advertisement 10, landing on the webpage (i.e. the advertisement begins as soon as the webpage loads, or at some predetermined time period after the webpage loads), etc. The trigger is thus a design choice. As illustrated in FIG. 2, a triggering event causes segments 20 (S1-S4) to begin being displayed (i.e. only a portion of the advertisement 10 is displayed). If the consumer leaves the webpage 100 before the advertisement 10 finishes displaying all of the segments S1-S10 (e.g. as illustrated in FIG. 2, after segment S4 is displayed) a tool such as a cookie, or some other method for determining user activity stores information about the last segment displayed so that when the consumer returns to the webpage 100 (FIG. 3) and activates the triggering mechanism, rather than displaying all of the segments S1-S4 which have already been displayed, the next set 30 of segments S5-S10 is displayed. If the consumer again leaves before all of the segments S5-S10 are displayed (e.g. as illustrated in FIG. 3, after segment S8 is displayed) then the cookie, or other method for determining user activity, stores information about the last segment (S8 in this instance) displayed so that when the consumer returns to the webpage 100 again the remaining segments (in this example S9-S10) can be displayed. Those skilled in the art will recognize that rather than begin the subsequent display with an entirely new segment (S5 as illustrated in FIG. 3 in this example), one or more embodiments may be configured to begin with one or more previously displayed segments (e.g. S4 or S3 and S4 as illustrated in FIGS. 4, 5) to refresh the consumer's recollection of the previously displayed content. While FIGS. 4 and 5 only illustrate at 40 and 50 respectively 1 or 2 segments being repeated from the previously displayed segments 20 in FIG. 1, the invention is not so limited. The number of segments that are repeated before displaying new segments is a design choice. Those skilled in the art will also recognize that depending upon how many segments are left to be displayed to complete the advertisement 10, the advertisement 10 may perform differently (e.g. it may replay more segments than it would if more segments were left to display, it may only show the new segments, etc.). In addition, since under certain conditions it is possible to track a particular consumer over multiple devices, the above description is also applicable to the user returning to the webpage 100 on a different device.

As illustrated in FIGS. 6 and 7, the segments 60 and 70 need not be presented in sequential order to fall within a scope of the invention. The segments 60 may be displayed in any order that makes design sense and then the remaining segments 70 may also be displayed in any order that makes design sense. By way of a non-limiting example, for a graphic advertisement, the image could be segmented into puzzle shaped pieces (not illustrated), or any other shaped segments and only certain pieces of the puzzle are displayed the first time the consumer triggers the advertisement. The next time additional or different pieces of the puzzle may be displayed until at some point all of the puzzle pieces may be displayed to show the entire advertisement. While FIGS. 6 and 7 illustrate the segments separated by odd and even numbered segments 60/70 the invention is not so limited. The advertisement 10 may be segmented in any order such that the order is a design choice.

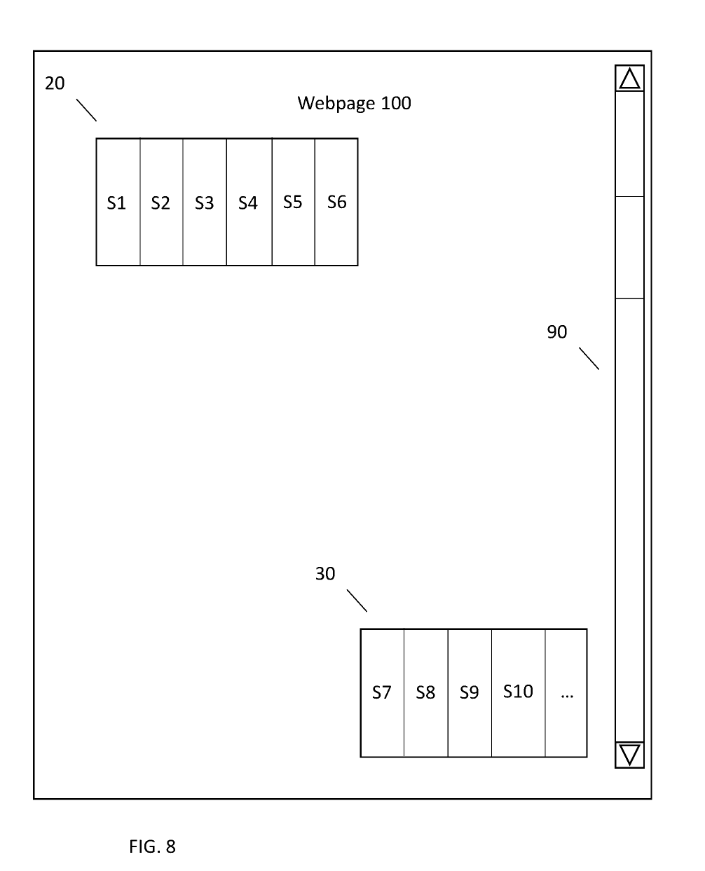

FIG. 8 illustrates one or more embodiments of the invention in which advertisement 10 is separated into various display areas 80/85 on the same webpage 100. While FIG. 8 illustrates only 2 areas, those skilled in the art will recognize that more than 2 areas may be utilized. As the consumer views one area of the webpage e.g. 80 the first segments S1-S6 of the advertisement will be displayed. As the consumer scrolls 90 through the webpage or otherwise navigates the webpage 100, the next set of segments S7-S10 will be displayed. Depending on the configuration of the advertisement, if the consumer navigates back to a previous area of the webpage (e.g. 80), the previous segments may be displayed again or the next set of segments may be displayed. As with the description above, there may be overlap with the displayed segments and the segments need not be displayed in sequential order to fall within a scope of the invention.

FIG. 9 illustrates an example of a system which may be employed to implement the above advertisement scheme. As illustrated, advertisement (“ad”) server 150 receives an advertisement and segments the advertisement into its various segments. Those skilled in the art will recognize that the advertisement may be segmented prior to receipt by the ad server 150 and still fall within a scope of one or more claims. Ad server 150 then serves the segmented advertisement via a communications network 160 such as the Internet for display on a mobile device 170. While a single ad server 150 a single mobile device 170 and a single network 160 are displayed, this is merely for ease of explanation. Those skilled in the art will recognize that one or multiple servers 150, mobile devices 170 and networks 160 may be employed.

Those skilled in the art will recognize that the above examples are merely a very small sample of the possibilities provided by one or more embodiments of the invention. There are a multitude of possibilities that could be provided within a scope of the invention.

Having thus described preferred embodiments of the invention, advantages can be appreciated. Variations from the described embodiments exist without departing from the scope of the invention. For example, rather than waiting for a consumer to return to the same webpage to display the additional segments of the advertisement, the consumers activity could be tracked such that when the consumer opens another webpage within the same website or within another website, the additional segments get displayed on that webpage. Thus it is seen that methods are provided for segmenting an advertisement and displaying different segments of the advertisement based on which segments have been previously displayed and which have not. Although particular embodiments have been disclosed herein in detail, this has been done for purposes of illustration only, and is not intended to be limiting with respect to the scope of the claims, which follow. In particular, it is contemplated by the inventors that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the invention described above are implemented, at least in part, using a computer system, it will be appreciated that a computer program for implementing at least part of the described methods and/or the described systems is envisaged as an aspect of the invention. The computer system may be any suitable apparatus, system or device, electronic, optical, or a combination thereof. For example, the computer system may be a programmable data processing apparatus, a computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

It is accordingly intended that all matter contained in the above description or shown in the accompanying drawings be interpreted as illustrative rather than in a limiting sense. It is also to be understood that the following claims are intended to cover all of the generic and specific features of the invention as described herein, and all statements of the scope of the invention which, as a matter of language, might be said to fall there between.

Having described the invention, what is claimed as new and secured by Letters Patent is:

1. A method for providing a graphical user interface for displaying a digital advertisement comprising:
an advertisement server receiving an advertisement;
said advertisement server transmitting said advertisement over a network for display on a consumer device; wherein said advertisement being transmitted is composed of a plurality of segments;
said advertisement server determining that not all of the plurality of segments were displayed on said consumer device;
said advertisement server in a subsequent transmission of said advertisement transmitting only one or more of said plurality of segments which were not previously displayed.

2. The method according to claim 1 wherein said advertisement is configured to be displayed within a webpage.

3. The method according to claim 1 wherein said advertisement is configured to be displayed within a mobile application.

4. The method according to claim 1 further including said advertisement server, in said subsequent transmission, transmitting at least one previously displayed segment other than a first of said plurality of segments along with said one or more of said plurality of segments which were not previously displayed.

5. The method according to claim 1 wherein each of said plurality of segments respectively has a duration and each duration is the same.

6. The method according to claim 1 wherein each of said plurality of segments respectively has a duration and at least two of said durations are different from each other.

7. The method according to claim 1 wherein each of the plurality of segments respectively has a shape and that shape is the same for each of said plurality of segments.

8. The method according to claim 1 wherein each of the plurality of segments respectively has a shape and at least two of said shapes are different from each other.

9. The method according to claim 1 further comprising said advertisement server dividing said advertisement into said plurality of segments.

10. The method according to claim 1 wherein said received advertisement is received already divided into said plurality of segments.

11. The method according to claim 1 wherein said subsequent transmission of said advertisement is for receipt by said consumer device.

12. The method according to claim 1 wherein said subsequent transmission of said advertisement is for receipt by another consumer device.

13. A method for providing a graphical user interface for displaying a digital advertisement comprising:
a mobile device receiving an advertisement which is divided into a plurality of segments;
said mobile device displaying at least one of the segments in response to a triggering event;
said mobile device terminating display of additional segments on said display prior to displaying each of said plurality of segments;
said mobile device keeping track of where the display of additional segments terminated; and,
a subsequent time said mobile device displays said advertisement said mobile device displaying only one or more of said plurality of segments which were not previously displayed.

14. The method according to claim 13 wherein said advertisement is displayed within a webpage.

15. The method according to claim 13 wherein said advertisement is displayed within a mobile application.

16. The method according to claim 13 further including said mobile device, in said subsequent display, displaying at least one previously displayed segment other than a first of said plurality of segments along with said one or more of said plurality of segments which were not previously displayed.

17. (canceled)

18. The method according to claim 13 wherein each of said plurality of segments respectively has a duration and at least two of said durations are different from each other.

19. (canceled)

20. The method according to claim 13 wherein each of plurality of segments respectively has a shape and at least two of said shapes are different from each other.

21. The method according to claim 13 wherein said mobile device keeps track of which segments have been displayed.

22. The method according to claim 13 wherein an advertisement server keeps track of which segments have been displayed.

23. The method according to claim 13 wherein said mobile device keeps track of which segments have not been displayed.

24. The method according to claim 13 wherein an advertisement server keeps track of which segments have not been displayed.

25. The method according to claim 13 wherein said mobile device keeps track of a last segment which has been displayed.

26. The method according to claim 13 wherein an advertisement server keeps track of a last segment which has been displayed.

27. The method according to claim 13 wherein said mobile device keeps track of a first segment which has not been displayed.

28. The method according to claim 13 wherein an advertisement server keeps track of a first segment which has not been displayed.

29. The method according to claim 13 wherein the advertisement is divided into said plurality of segments after it is received.

30. A method for providing a graphical user interface for displaying a digital advertisement comprising:
a mobile device receiving an advertisement, said advertisement being divided into a plurality of segments;
said mobile device displaying at least one of the segments on an area of a webpage in response to a triggering event;
said mobile device stopping a display of additional segments of said advertisement upon a user navigating away from area of the webpage to another area of the webpage; and, said mobile device displaying at least another of the plurality of segments on the another area of the webpage in response to a determination that all of the plurality of segments were not previously displayed.

31. (canceled)

32. The method according to claim 30 wherein each of said plurality of segments respectively has a duration and at least two of said durations are different from each other.

33. (canceled)

34. The method according to claim 30 wherein each of the plurality of segments respectively has a shape and at least two of said shapes are different from each other.
